(19) United States
(12) Patent Application Publication
(10) Pub. No.: US 2010/0226552 A1
(43) Pub. Date: Sep. 9, 2010

(54) IDENTIFICATION AND VISUALIZATION OF REGIONS OF INTEREST IN MEDICAL IMAGING

(75) Inventor: Ahmet Ekin, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/293,558

(22) PCT Filed: Mar. 23, 2007
(86) PCT No.: PCT/IB07/51033

§ 371 Date: Sep. 19, 2008

(30) Foreign Application Priority Data
Mar. 28, 2006 (EP) 06111794.1

(51) Int. Cl. G06K 9/00

(52) U.S. Cl. 382/131

(57) ABSTRACT

A system and method for displaying image data acquired in respect of, for example, a subject's brain. MRI image data is acquired (300) and a first contrast image, for example, MR T2 contrast mage is used to determine (304) the repair of hypo-intensity indicative of iron concentration. A second image is obtained (310) either by segmentation or by using a different type of contrast image, for example, T1 or PD, in which the boundaries between brain organs can be visibly determined. The regions of hypo-intensity (including the respective spatial resolution) is combined (312) with the second image to generate (314) an aggregate image showing the regions of hypo-intensity in association with the respective brain organs.

This invention relates generally to the identification and visualisation of specific regions of a volume of interest in a medical imaging application, for diagnostic purposes.

Neurodegenerative diseases are becoming widespread and, although most are not curable, the early detection of such diseases can enable the effective use of drug therapy to delay their progress. Many neurodegenerative diseases, such as Alzheimer's and Parkinson's disease, are associated with an increased iron concentration in the brain, and physicians often use magnetic resonance (MR) images to determine the spread of iron deposition in a subject's brain, for the evaluation of neurodegenerative diseases.

Magnetic resonance imaging (MRI) is a widely used technique for medical diagnostic imaging. In a conventional MRI scanner, a patient is placed in an intense static magnetic field which results in the alignment of the magnetic moments of nuclei with non zero spin quantum numbers, either parallel or anti-parallel to the field direction. Boltzmann distribution of moments between the two orientations results in a net magnetisation along the field direction. This magnetisation may be manipulated by applying a radio frequency (RF) magnetic field at a frequency determined by the nuclear species under study (usually hydrogen atoms present in the body, primarily in water molecules) and the strength of the applied field. The energy absorbed by nuclei from the RF field is subsequently re-emitted and may be detected as an oscillating electrical voltage, or free induction decay signal, in an appropriately tuned antenna and image processing means are employed to reconstruct an image, which image is based on the location and strength of the incoming signals.

When utilising these signals to produce images, magnetic field gradients Gₓ, G_{y} and G_{z} are employed. Typically, the region to be imaged is scanned by a sequence of measurement cycles in which these gradients vary according to the particular localisation method being used. The resulting series of views that is acquired during the scan form a nuclear magnetic resonance (NMR) image data set from which an image can be reconstructed using one of many well-known reconstruction techniques.

Different contrast images can be obtained from the acquired image by selecting a particular parameter to define the relative pixel or voxel intensities in the image. In order to understand MRI contrast, it is important to have some understanding of the time constants involved in relaxation processes that establish equilibrium following RF excitation. As the high-energy nuclei relax and realign, they emit energy at rates which are recorded to provide information about their environment. The realignment of nuclear spins with the magnetic field is termed longitudinal relaxation and the time (typically about 1 sec) required for a certain percentage of the tissue nuclei to realign is termed “Time 1” or T1, wherein T1 is defined as the time required for the magnetisation vector M to be restored to 63% of the original magnitude. It varies with the magnetic field intensity.

T2-weighted imaging, on the other hand, relies upon local dephasing of spins following the application of the transverse energy pulse; the transverse relaxation time (typically <100 ms for tissue) is termed “Time 2” or T2, wherein T2 is defined as the time required for the transverse Magnetisation vector to drop to 37% of its original magnitude after its initial excitation. Unlike T1, T2 varies with the field strength and is a property of the tissue.

Image contrast is created by using a selection of image acquisition parameters that weights signal by T1, T2 or no relaxation time (“proton-density images”), as will be well known to a person skilled in the art. Because iron is a ferromagnetic element, it affects the MR T2 image contrast by reducing the intensity value of iron-rich tissues, resulting in a contrast image having hypo-intense regions. However, not all hypo-intense regions are clinically relevant. More specifically, only several of the basal ganglia organs of the brain (caudate nucleus, globus pallidus and putamen) and thalamus have significance in this case. Generally, iron concentration first starts to increase in the globus pallidus (stage 1), i.e. region 3 in FIG. 5, and, once the globus pallidus iron concentration reaches a certain level, it spreads to the neighbouring organ, putamen (stage 2), i.e. region 1 in FIG. 5. Because globus pallidus is a smaller organ than putamen and because they are adjacent to each other, practitioners can often have difficulty distinguishing stage 1 from stage 2 using the T2 contrast image, because tissue and organ boundaries are blurred therein due to the iron deposition.

U.S. Pat. No. 6,430,430 describes a method and system for using MR images to identify hyperintensive regions of the brain and thereby locate suspected lesions in the brain. However, in the case of neurodegenerative diseases, as set out above, it is not sufficient to simply identify areas of iron deposition in the brain, it is also necessary to precisely determine which organs of the brain are affected and to what extent, and the arrangement described in U.S. Pat. No. 6,430,430 does not provide an accurate way for this information to be provided to the practitioner.

It is therefore an object of the present invention to provide a system and method of medical imaging, whereby the location and size of specific diagnostic regions of a volume of interest can be accurately identified and then visualised or otherwise processed in association with defined areas of the volume of interest, so that their location relative thereto can be accurately determined.

In accordance with the present invention, there is provided a medical imaging system, comprising:

a) means for receiving acquired image data in respect of a volume of interest comprising two or more defined areas having a respective boundary therebetween;

b) means for deriving a first contrast image comprising a representation of said acquired image data based on intensity values of picture elements thereof, wherein said intensity values are defined by a selected parameter;

c) means for identifying from said first contrast image, picture elements having a respective intensity value falling within a predefined range of intensity values, and generating diagnostic image data representative of said picture elements and the spatial resolution thereof relative to said first contrast image;

d) means for deriving a second image data set comprising a representation of said acquired image data in which the boundaries between said two or more defined areas are determinable; and

e) means for combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.

Thus, the present invention provides a medical imaging system, whereby two types of image derived from the acquired image data are used to obtain the information required by the practitioner. A first contrast image is used to determine the location and size of diagnostic data representative of a specific parameter. The spatial resolution of this data is maintained, and the image data is combined with a second image which clearly indicates the boundaries between defined areas of the volume of interest so that the extent and location of the diagnostic image data relative to specific defined areas of the volume of interest can be accurately analysed.

In a preferred embodiment, the system preferably comprises means for defining a volume of interest (VOI) prior to generating said diagnostic image data, wherein said diagnostic image data is only generated in respect of said volume of interest. In a preferred embodiment, the means for defining said volume of interest includes segmentation means for generating a mask for eliminating one or more regions of said first contrast image from said volume of interest.

Beneficially, said acquired image data comprises magnetic resonance image (MRI) data and said first contrast image is a T2 MR image derived therefrom. In a preferred embodiment, the system includes means for building a histogram of picture element intensities from said first contrast image and then selecting a predetermined percentage of the highest or lowest intensities to define said diagnostic image data. In one exemplary embodiment, the diagnostic image data comprises iron concentration in said volume of interest, and a percentage, possibly of the order of 5-10% of the lowest intensity vaalues are selected to define the diagnostic image data.

In a first exemplary embodiment, the second image data set is derived by segmenting multiple images derived from the acquired image data and reconstructing an image in which the boundaries between said two or more defined areas are determinable. In an exemplary embodiment, the areas may comprise selected organs of the brain. In an alternative embodiment, the second image data set may comprise an MR contrast image, different to said first contrast image, in which the boundaries between said two or more defined areas are visibly determinable.

In one exemplary embodiment, means may be provided for analysing said diagnostic image data, wherein said image data is only displayed in the event that said diagnostic image data is determined to indicate a requirement for further visual investigation.

The present invention also extends to a medical imaging apparatus, comprising image acquisition means for acquiring one or more images of a volume of interest including two or more defined areas having respective boundaries therebetween, a system as defined above for generating for display image data representative of said volume of interest including a visible indication of said boundaries between said two or more defined areas and the locations relative thereto of said picture elements having a respective intensity value falling within said predefined range of intensity values, and display means for displaying said image data.

The present invention extends still further to a method of generating for display image data representative of a volume of interest, the method comprising:

a) receiving acquired image data in respect of said volume of interest comprising two or more defined areas having a respective boundary therebetween;

b) deriving a first contrast image comprising a representation of said acquired image data based on intensity values of picture elements thereof, wherein said intensity values are defined by a selected parameter;

c) identifying from said first contrast image, picture elements having a respective intensity value falling within a predefined range of intensity values, and generating diagnostic image data representative of said picture elements and the spatial resolution thereof relative to said first contrast image;

d) deriving a second image data set comprising a representation of said acquired image data in which the boundaries between said two or more defined areas are determinable; and

e) combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.

Also in accordance with the present invention, there is provided a computer implemented image processing method of generating for display image data representative of a volume of interest, comprising:

a) receiving acquired image data in respect of a volume of interest comprising two or more defined areas having a respective boundary therebetween;

b) deriving a first contrast image comprising a representation of said acquired image data based on intensity values of picture elements thereof, wherein said intensity values are defined by a selected parameter;

c) identifying from said first contrast image, picture elements having a respective intensity value falling within a predefined range of intensity values, and generating diagnostic image data representative of said picture elements and the spatial resolution thereof relative to said first contrast image;

d) deriving a second image data set comprising a representation of said acquired image data in which the boundaries between said two or more defined areas are determinable; and

e) combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.

The invention extends further to a computer program for performing an image processing method for use with medical imaging apparatus comprising image acquisition means for acquiring one or more images of a volume of interest including two or more defined areas having a respective boundary therebetween and image display means, the computer program comprising software code for:

a) receiving acquired image data in respect of a volume of interest comprising two or more defined areas having a respective boundary therebetween;

b) deriving a first contrast image comprising a representation of said acquired image data based on intensity values of picture elements thereof, wherein said intensity values are defined by a selected parameter;

c) identifying from said first contrast image, picture elements having a respective intensity value falling within a predefined range of intensity values, and generating diagnostic image data representative of said picture elements and the spatial resolution thereof relative to said first contrast image;

d) deriving a second image data set comprising a representation of said acquired image data in which the boundaries between said two or more defined areas are determinable; and

e) combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.

These and other aspects of the present invention will be apparent from, and elucidated with reference to the embodiments described herein.

Embodiments of the present invention will now be described by way of examples only and with reference to the accompanying drawings, in which:

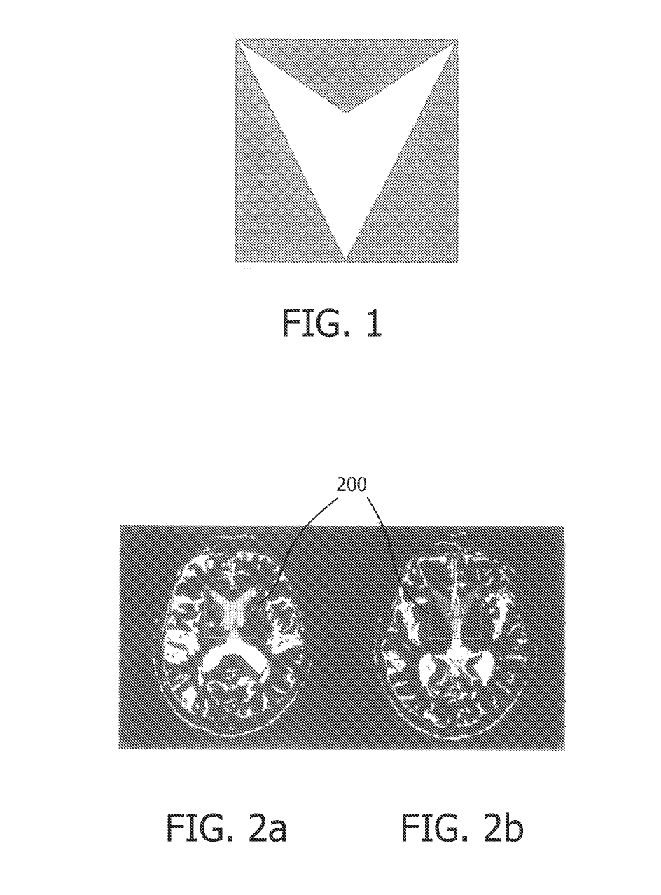

FIG. 1 is a schematic illustration of the approximate model of the CSF shape used in defining a VOI in a method according to an exemplary embodiment of the present invention;

FIG. 2 illustrates the shape model of FIG. 1 overlaid a) onto the slice in the VOI with the feature value 3.25, and b) on a slice outside the VOI with feature value 1.04;

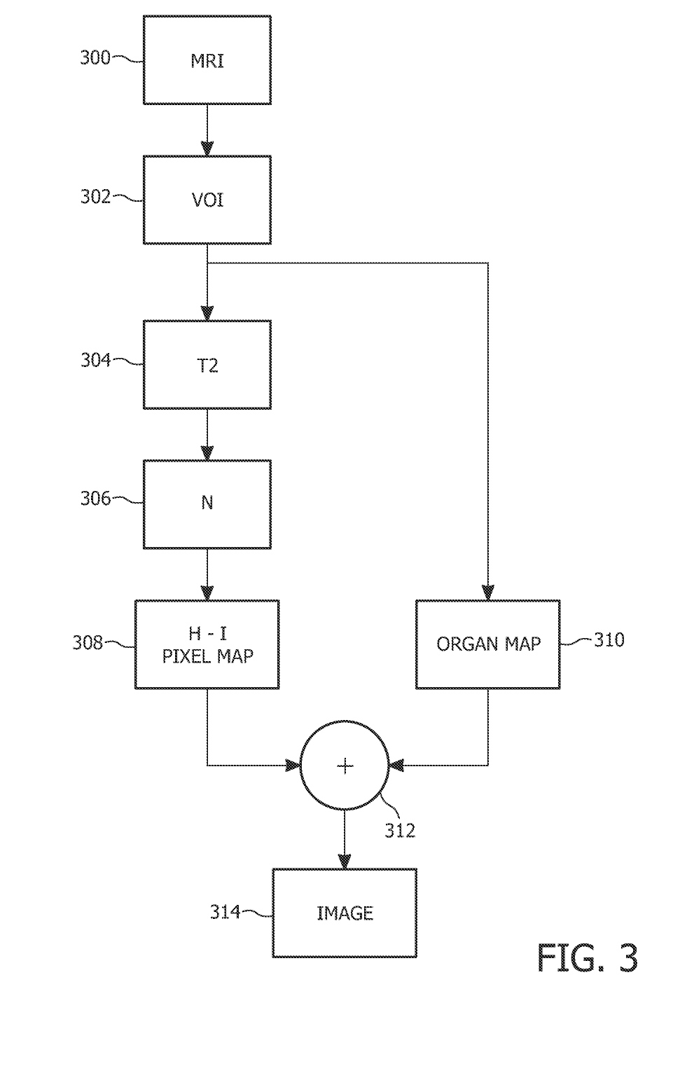

FIG. 3 is a schematic flow diagram illustrating the principle steps of a method according to an exemplary embodiment of the present invention;

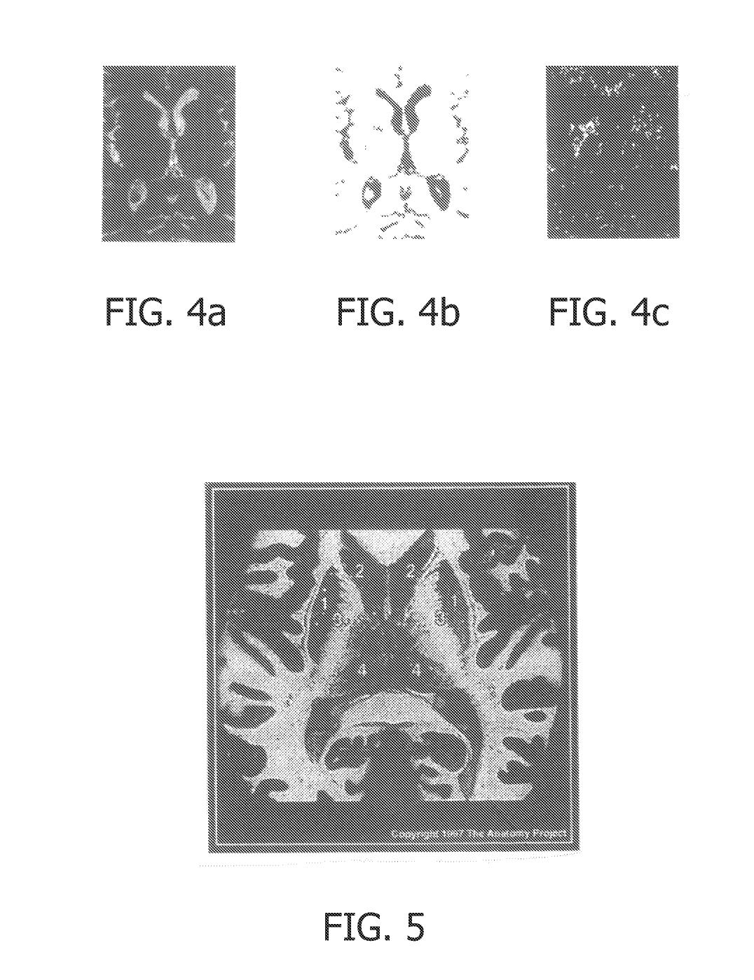

FIG. 4 illustrates a) a T2 image in the VOI, b) CSF and background removed mask, and c) a spatial map of hypo-intense voxels;

FIG. 5 illustrates an atlas of several basal ganglia organs and thalamus: region 1=putamen, region 2=caudate nucleus, region 3=globus pallidus, region 4=thalamus;

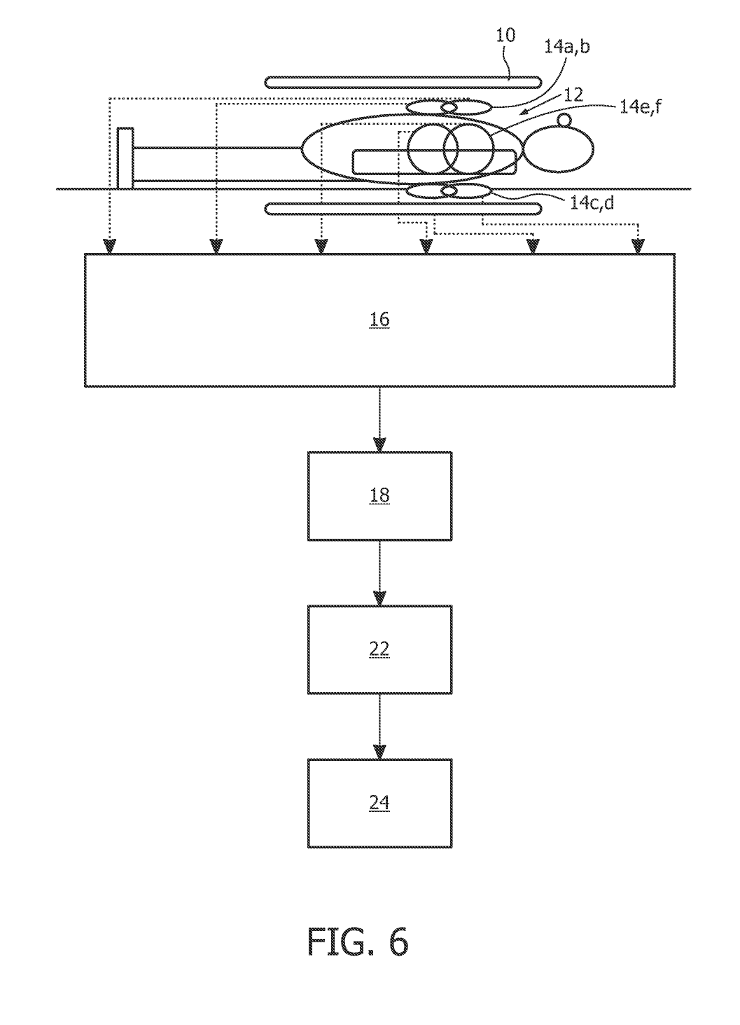

FIG. 6 is a schematic diagram illustrating the principal components of MRI apparatus according to an exemplary embodiment of the present invention;

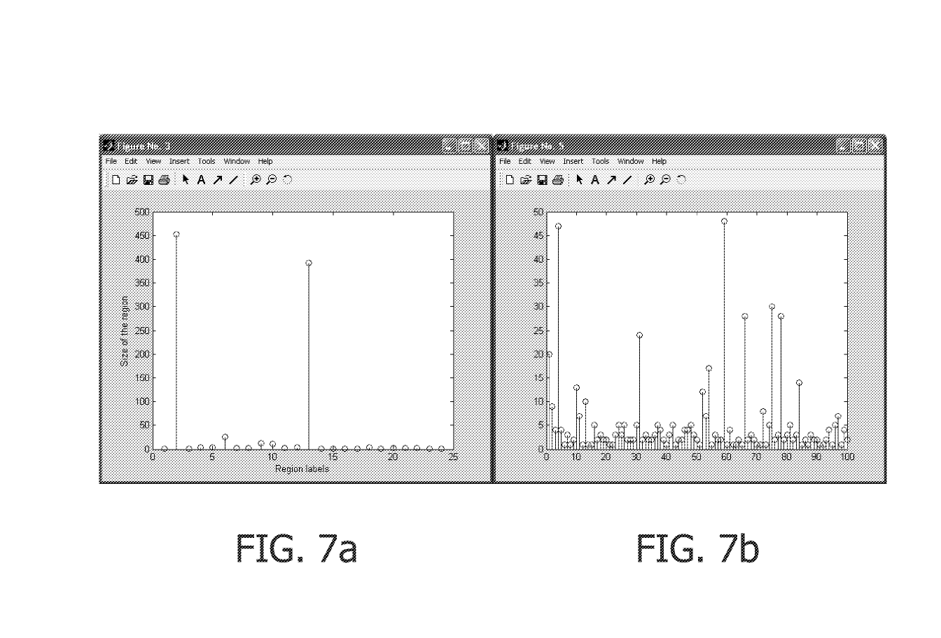

FIG. 7 is a typical graphical representation of connected hypo-intense regions for a) a sick and b) a healthy patient; and

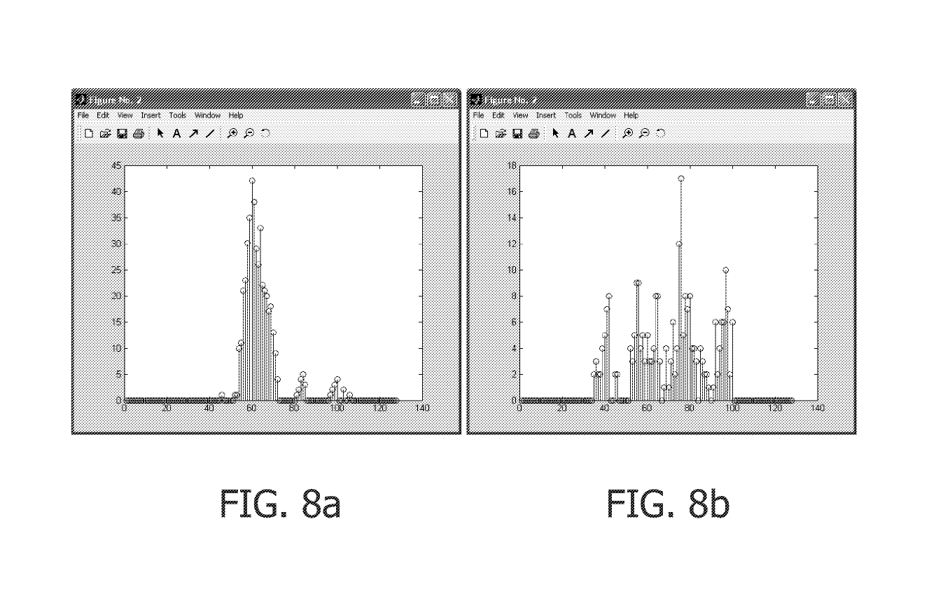

FIG. 8 is a typical graphical representation of the vertical projection of hypo-intense voxels for a) a sick patient and b) a healthy patient.

Thus, the primary object of the following exemplary embodiment of the present invention is the detection of the regions of a patient's brain which give rise to hypo-intensive picture element values, and the visualisation of these regions relative to an image of the brain which visibly indicates the boundaries between the relevant organs of the brain, so that the practitioner can evaluate the health status of the patient more accurately than has previously been possible.

Referring to FIG. 6 of the drawings, MRI apparatus according to an exemplary embodiment of the present invention comprises a large, cylinder-shaped magnet 10 in which a patient 12 lies. A plurality of RF coils 14 are provided within the cylindrical magnet 10 to receive NMR signals that are produced during the MRI scan. Two coil elements 14a, b are positioned anterior to the imaging volume and two coil elements 14c, d are positioned posterior thereto. A third pair of coild elements 14e, f is provided at the side of the imaging volume. Together, the coils a, b, c, d, e and f for a local coil array, and it will be appreciated by a person skilled in the art that the present invention is not limited to any particular local coil array and many alternative local coils are commercially available and suitable for this purpose. The NMR signals picked up by the coil elements 14 are digitised by a transceiver module 16 and transferred to an image reconstruction module 18. The method of the present invention is performed in a processing module 22 (which may include the image reconstruction module 18) and the resultant image data is displayed on a screen 24.

In a method according to an exemplary embodiment of the present invention, first, a volume of interest (VOI) in relation to an acquired MR image is defined, the VOI defining the region of the acquired image in which the subsequent processing will be performed. The volume of interest may, of course, simply be defined as the entire brain or area covered by the acquired image, and the processing methodology described hereinafter is perfectly able to handle this case. However, in order to reduce the processing requirement, some pre-processing may be performed to define a volume of interest within the area covered by the acquired image. This may, of course, be performed manually by the practitioner, who may simply select the volume of interest based on a displayed image. However, in the following, an automatic volume-of-interest detection algorithm will be described.

The proposed algorithm consists of two stages:

a) CSF (cerebrospinal fluid)−background−(White Matter (WM)+(GM)) segmentation from T2 and proton density (PD) contrast images; and

b) Shape-based VOI detection from the CSF region.

In the first stage, the object is to perform segmentation in respect of the acquired image, the result of which segmentation is then utilised for two purposes:

1) to use the resultant CSF mask in the detection of the VOI; and

2) to use the WM+GM region in the hypo-intense region detection stage.

MR images of the human brain typically contain three tissue classes: grey matter (GM), white matter (WM) and cerebrospinal fluid (CSF), and cluster analysis will be well known to a person skilled in the art as one of the most common methods of automatic brain tissue classification. In this exemplary embodiment of the present invention, the segmentation of the acquired MRI data may be performed using an unsupervised segmentation algorithm based on a clustering algorithm, whereby clustering is performed with respect to three classes that correspond to background, CSF and everything else (including WM, GM, skull muscle, etc) respectively. The cluster with the highest T2 value can then be assigned as the CSF region. Unsupervised segmentation algorithms based on clustering algorithms like fuzzy-c means (FCM) and k-means (for faster processing because it is assumed that each picture element belongs exclusively to one class) will be well known to a person skilled in the art, and will not be discussed in any further detail herein.

Once the CSF mask has been determined in this manner, the VOI is determined by using a shape model. VOI refers to the image slices where the organs of interest, e.g. basal ganglia, are visible. They tend to be most clearly visible in three or four slices for 3 mm slice thickness. In an axial view, these slices can be detected from the shape characteristics of the ventricle. Bearing in mind that the CSF is symmetrical on a vertical axis through the centre of the ventricular area, it can be observed that the shape of the upper half of the CSF region (the frontal lobe of the lateral ventricle) is largely consistent across a large population. It is proposed herein, therefore, to emply an approximate shape model that can be verified with minimal computation. Referring to FIG. 1 of the drawings, a proposed head size adaptive shape model is illustrated. The generally V-shaped region approximates the CSF region in the VOI. If, for the purposes of the proposed method, a feature is defined as the ratio of the number of CSF pixels in the V-shaped region to the number of CSF pixels outside this region but inside the rectangular region 200 shown in FIG. 2, then the VOI is determined as the window of slices (window size being a function of slice thickness and distance between slices), 3 in the present case, having the maximum sum of the proposed feature value. This determines the VOI which is provided as a mask for processing.

Thus, referring to FIG. 3 of the drawings, in a method according to an exemplary embodiment of the present invention, MR images are acquired in respect of a patient (at step 300) and a volume of interest (VOI) is determined for processing (at step 302). Next, an algorithm for use in the detection of hypo-intense regions of the VOI will be described.

Given the VOI mask provided at step 302, a histogram of T2 intensity values of the pixels in the VOI is built (at step 304). Once the intensity values of all pixels in the VOI are known, the bottom N % are selected (at step 306) to be defined as the hypo-intense region of the VOI. In other words, using the mask, the CSF and background regions of the VOI can be excluded from consideration and the N % of the remaining pixels having the lowest T2 intensity is selected to define the hypo-intense region of the VOI, and a hypo-intensity pixel map is generated at step 308, wherein the hypo-intense pixels and their spatial resolution are combined to generate diagnostic image data. As a result, the method of determining the hypo-intense regions of the image is adaptive in the sense that relative intensities are used, rather than absolute intensities which can vary greatly depending on input constraints used. N may, for example, be of the order of 5% or 10%, depending on user preference and/or the image content remaining when the cerebrospinal fluid (CSF) region (the brightest T2 region) and the background region (usually the darkest T2 region) have been excluded. If, when the VOI is defined, the mask still includes the background region (and only excludes the CSF region), the background region can be eliminated from the histogram built at step 304 by detecting the leftmost and rightmost peaks of the histogram and eliminating these prior to the definition of the hypo-intense region.

Defining the bottom N % of the histogram as hypo-intense pixels will result in equal amounts of hypo-intense pixels in patients with high amounts of iron concentration as in patients with normal amounts of iron. However, the spatial distribution of the hypo-intense pixels will differ significantly. High iron concentration will result in hypo-intense regions in mostly basal ganglia organs of the brain, whereas the distribution in healthy subjects will be random and noise-like. FIG. 4 shows (a) the T2 contrast of a healthy subject, (b) the mask built by eliminating CSF and background regions (shown as black pixels in the mask), and (c) the resulting hypo-intense pixel map after the application of the algorithm described above. As shown in the image, T2 MR contrast does not provide much detail for tissue boundaries (white matter-grey matter) in the VOI. As a result, associating the hypo-intense region with the organ locations is very difficult from the T2 images. Next, the proposed method of visualising the hypo-intense region map relative to the organ locations for improved diagnosis will be described.

As explained, hypo-intense regions need to be associated with organs of the brain in order to make an accurate diagnosis. In order to do this in this exemplary embodiment of the invention, an organ map is generated (at step 310). In the following, two exemplary embodiments are proposed in order to fulfill this requirement.

The first of these involves segmenting the acquired brain images using multiple MR contrasts, detecting the organs of interest and their boundaries using landmark and brain atlas information, and then combining (at step 312) the resultant organ map resulting from the segmentation process and the hypo-intense region map to produce an image at step 314 showing the hypo-intense regions in relation to the organs. As explained above, segmentation of MR images is well known in the art, and many different ways in which this can be achieved may be envisaged by a person skilled in the art. For example, by extending the above-mentioned clustering algorithm to a larger number of classes (e.g. to include WM, GM, muscle, etc) and employing a brain atlas such as that shown in FIG. 5, it is possible to reproduce an organ map in respect of the acquired image data.

In an alternative exemplary embodiment, the observation may be used that some MR contrasts, such as T1 and PD, usually inherently possess visibly noticeable intensity differences between basal ganglia organs. In this case, therefore, the organ segmentation step may actally be eliminated for such contrasts. Instead of computing the segmentation map and combining it with the hypo-intense region map, it is proposed to overlay the hypo-intense region map onto a non-T2 MR contrast in which the boundaries of the organs of interest are visibly distinguishable. Examples of such contrasts include T1 and proton-density (PD), but other suitable contrasts are, of course, envisaged.

The resultant image will show randomly-distributed hypo-intense regions in a healthy subject and, in contrast, for patients with a high iron deposition, the hypo-intense pixels will form compact regions. The second image, in which the relevant organs are distinguishable from each other, enables a practitioner to see, not only whether or not the patient has any compact hypo-intense regions, but also if such regions remain in the globus pallidus (stage 1) or have extended into the putamen (stage 2). The most important feature is that the practitioner can quickly conclude the iron accumulation of the patient.

The VOI for the visualisation step can be defined as being the same as that used for the processing steps, or a subset of it. For example, visualisation may include only the grey matter regions of the original VOI by using the fact that the basal ganglia organs are also regarded as deep grey matter organs. It is also possible that the display can be a function of some processing result of the hypo-intense region mask. For example, the system may set the display option as a function of the size of the hypo-intense region, where a region is defined as a connected set of voxels. In a particular case, the largest hypo-intense regions in the left and right hemispheres of each slice can be shown.

Thus, the spatial distribution feature of the present invention is a measure of the distribution of hypo-intense pixels; as such, it gives information as to the likelihood of healthiness or sickness of the patient. As an extension to the present invention, this feature can be used by the system to automatically decide whether the hypo-intense map needs to be overlaid on a tissue segmentation map or another contrast, such as PD or T1, or not.

In the following, a number of examples will be given in relation to computation of a spatial distribution feature of the hypo-intense map derived using the method of the present invention, together with some examples of typical values in sick and healthy patients. These examples are intended to demonstrate the effectiveness of the proposed features, wherein in addition to their use as a condition of display, further advantages include the possibility for automatic classification of the patient by their health status and the elimination of the requirement for organ segmentation.

In the following, spatial distribution features may be based on a morphological approach or a projection-based approach.

In the morphological approach, morphological image processing operators are used. First, connected hypo-intense regions are labelled such that connected groups of hypo-intense voxels are given the same label (number). The features of these regions can then be used to classify whether or not the patient may be sick. FIG. 7 shows typical plots of the size of the regions for a) a sick patient and b) a healthy patient. Depending on the following features, sick and healthy patients can be identified in a number of ways:

size of the largest region: when the size of the largest region is greater than a predetermined amount (a function of the head size in voxels), the patient can be classified as sick;

size of the largest two regions: in most cases, both hemispheres of the brain have similar-sized large hypo-intense regions. This observation can be utilised by any of the following:
i) the average size of the two largest regions should be larger than some predefined number; and:
ii) the size of the two largest regions should not differ significantly from each other; or
iii) they should occur in different hemispheres (either side of the mid-sagittal plane, for example.

Largest region size/the number of regions: the saliency of a region can be measured relative to the context. This feature is expected to be small when the patient is healthy, whereas it should be relatively large for sick patients. For healthy patients, values less than 1 have been observed, whereas sick patients will have values larger than 1. The examples illustrated in FIG. 7 show values of a) 18.8 and b) 0.48.

In the projection based approach, it has been observed that the features of the vertical projection of hypo-intense voxels can be used for healthy and non-healthy classification. In this case, the following features can be used for classification:

The location of the peak;

The width of the largest non-zero run having the peak location: this should not be very large for sick patients;

The ratio of the total number of hypo-intense voxels in the above-mentioned largest non-zero run/the total number of hypo-intense voxels: this is larger for sick patients because most hypo-intense voxels should be close to each other and in the basal ganglia region.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A medical imaging system, comprising:
a) means for receiving acquired image data in respect of a volume of interest comprising two or more defined areas having a respective boundary therebetween;
b) means for deriving a first contrast image comprising a representation of said acquired image data based on intensity values of picture elements thereof, wherein said intensity values are defined by a selected parameter;
c) means for identifying from said first contrast image, picture elements having a respective intensity value falling within a predefined range of intensity values, and generating diagnostic image data representative of said picture elements and the spatial resolution thereof relative to said first contrast image;
d) means for deriving a second image data set comprising a representation of said acquired image data in which the boundaries between said two or more defined areas are determinable; and
e) means for combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.

2. A system according to claim 1, comprising means for defining a volume of interest (VOI) prior to generating said diagnostic image data, wherein said diagnostic image data is only generated in respect of said volume of interest.

3. A system according to claim 2, wherein the means for defining said volume of interest includes segmentation means for generating a mask for eliminating one or more regions of said first contrast image from said volume of interest.

4. A system according to claim 1, wherein said acquired image data comprises magnetic resonance image (MRI) data and said first contrast image is a T2 MR image derived therefrom.

5. A system according to claim 1, wherein the system includes means for building a histogram of picture element intensities from said first contrast image and then selecting a predetermined percentage of the highest or lowest intensities to define said diagnostic image data.

6. A system according to claim 1, wherein the second image data set is derived by segmenting multiple images derived from the acquired image data and reconstructing an image in which the boundaries between said two or more defined areas are determinable.

7. A system according to claim 1, wherein the second image data set comprises a contrast image, different to said first contrast image, in which the boundaries between said two or more defined areas are visibly determinable.

8. A system according to claim 1, wherein means are provided for analysing said diagnostic image data, wherein said image data is only displayed in the event that said diagnostic image data is determined to indicate a requirement for further visual investigation.

9. A medical imaging apparatus, comprising image acquisition means for acquiring one or more images of a volume of interest including two or more defined areas having respective boundaries therebetween, a system according to claim 1, for generating for display image data representative of said volume of interest including a visible indication of said boundaries between said two or more defined areas and the locations relative thereto of said picture elements having a respective intensity value falling within said predefined range of intensity values, and display means for displaying said image data.

10. A method of generating for display image data representative of a volume of interest, the method comprising:
a) receiving acquired image data in respect of said volume of interest comprising two or more defined areas having a respective boundary therebetween;
b) deriving a first contrast image comprising a representation of said acquired image data based on intensity values of picture elements thereof, wherein said intensity values are defined by a selected parameter;
c) identifying from said first contrast image, picture elements having a respective intensity value falling within a predefined range of intensity values, and generating diagnostic image data representative of said picture elements and the spatial resolution thereof relative to said first contrast image;
d) deriving a second image data set comprising a representation of said acquired image data in which the boundaries between said two or more defined areas are determinable; and
e) combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.

11. A computer implemented image processing method of generating for display image data representative of a volume of interest, comprising:
a) receiving acquired image data in respect of a volume of interest comprising two or more defined areas having a respective boundary therebetween;
b) deriving a first contrast image comprising a representation of said acquired image data based on intensity values of picture elements thereof, wherein said intensity values are defined by a selected parameter;
c) identifying from said first contrast image, picture elements having a respective intensity value falling within a predefined range of intensity values, and generating diagnostic image data representative of said picture elements and the spatial resolution thereof relative to said first contrast image;
d) deriving a second image data set comprising a representation of said acquired image data in which the boundaries between said two or more defined areas are determinable; and
e) combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.

12. A computer program for performing an image processing method for use with medical imaging apparatus comprising image acquisition means for acquiring one or more images of a volume of interest including two or more defined areas having a respective boundary therebetween and image display means, the computer program comprising software code for:
a) receiving acquired image data in respect of a volume of interest comprising two or more defined areas having a respective boundary therebetween;
b) deriving a first contrast image comprising a representation of said acquired image data based on intensity values of picture elements thereof, wherein said intensity values are defined by a selected parameter;
c) identifying from said first contrast image, picture elements having a respective intensity value falling within a predefined range of intensity values, and generating diagnostic image data representative of said picture elements and the spatial resolution thereof relative to said first contrast image;
d) deriving a second image data set comprising a representation of said acquired image data in which the boundaries between said two or more defined areas are determinable; and
e) combining said diagnostic image data and said second contrast image so as to generate for display image data representative of said volume of interest including a visible indication of said boundaries between said two or more defined areas and the locations relative thereto of said picture elements having a respective intensity value falling within said predefined range of intensity values.
